(19) United States
(12) Patent Application Publication
(10) Pub. No.: US 2016/0003732 A1
(43) Pub. Date: Jan. 7, 2016

(54) DEVICES TO DETECT A SUBSTANCE AND METHODS OF PRODUCING SUCH A DEVICE

(71) Applicant: HEWLETT-PACKARD DEVELOPMENT COMPANY, L.P., Houston, TX (US)

(72) Inventors: Zhiyong LI, Foster City, CA (US); Ning GE, Palo Alto, CA (US); Steven J. BARCELO, Palo Alto, CA (US); Huei Pei KUO, Cupertino, CA (US)

(73) Assignee: Hewlett-Packard Development Company, L.P., Houston, TX (US)

(21) Appl. No.: 14/775,863

(22) PCT Filed: Mar. 14, 2013
(86) PCT No.: PCT/US2013/031611

§ 371 Date: Sep. 14, 2015

(51) Int. Cl. G01N 21/15; C23C 18/32; C25D 5/34; C25D 7/00; G01N 21/65; G01N 21/64

(52) U.S. Cl. CPC G01N 21/15; G01N 21/658; G01N 21/6428; G01N 21/648; C25D 5/34; C25D 7/00; C23C 18/32; G01N 2021/0106

(57) ABSTRACT

Devices to detect a substance and methods of producing such a device are disclosed. An example device to detect a substance includes an orifice plate defining a first chamber. A substrate is coupled to the orifice plate. The substrate includes nanostructures positioned within the first chamber. The nanostructures are to react to the substance when exposed thereto. A seal is to enclose at least a portion of the first chamber to protect the nanostructures from premature exposure.

### BACKGROUND

Surface Enhanced Raman Spectroscopy (SERS) may be used in various industries to detect the presence of an analyte. For example, SERS may be used in the security industry to detect and/or scan for explosives (e.g., detecting and/or scanning baggage at airports for explosives and/or other hazardous materials). Alternatively, SERS may be used in the food industry to detect toxins or contaminates in water and/or milk.

### BRIEF DESCRIPTION OF THE DRAWINGS

FIG. 1 depicts an example testing device constructed in accordance with the teachings of this disclosure.

FIG. 2 depicts another example testing device with a seal coupled to an example orifice plate in accordance with the teachings of this disclosure.

FIG. 3 depicts the example testing device of FIG. 2 with an analytic solution being added to the chamber.

FIG. 4 depicts the example testing device of FIG. 2 and an example reading device constructed in accordance with the teachings of this disclosure.

FIGS. 5-12 depict an example process of producing an example orifice plate that can be used to implement the example testing device of FIGS. 1 and/or 2.

FIG. 13 depicts a multi-chamber testing device constructed in accordance with the teachings of this disclosure.

FIG. 14 illustrates an example method of making the example testing devices of FIGS. 1-4 and 13.

Certain examples are shown in the above-identified figures and described in detail below. The figures are not necessarily to scale and certain features and certain views of the figures may be shown exaggerated in scale or in schematic for clarity and/or conciseness.

### DETAILED DESCRIPTION

Many applications have a need for a reliable device that can be employed to detect the presence of a substance of interest. For example, such testing or detecting devices are useful to detect the presence of explosives, toxins or hazardous substances at airports, manufacturing facilities, food processing facilities, drug preparation plants, etc. The substrates of some known testing and/or detecting devices are not sufficiently protected against premature exposure to the environment and/or a substance (e.g., an analyte) that the substrate is intended to detect. Prematurely exposing the substrate to the environment and/or the substance (e.g., an analyte) may cause the substrate to oxidize and/or to not be as effective in detecting the substance once intentionally exposed thereto.

Example testing and/or detecting devices for the analysis of various substances are disclosed herein. In some such examples, the testing device is for use with surface Enhanced Raman spectroscopy, Enhanced Fluorescence spectroscopy or Enhanced Luminescence spectroscopy, which may be used to detect the presence of the substance of interest in or on the testing or detecting device. Example testing devices disclosed herein include metal orifice plates and/or housings that protect a substrate of the testing device from exposure to the environment and/or reduce (e.g., prevent) oxidation or other contamination of the substrate and/or associated surface structures prior to use. More specifically, the orifice plates disclosed reduce or even prevent the unintentional exposure of nanoparticles, metallic nanoparticles or microparticles, nanostructures, SERS strip, etc., of the substrate to a substance such as an analyte that the nanoparticles, metallic nanoparticles or microparticles, nanostructures, SERS strip, etc., are intended to detect.

In some examples, the orifice plates disclosed herein are produced using a glass mandrel (e.g., soda-lime-silica glass or wafer) having pattern(s) and/or structure(s) to produce associated structure(s) and/or aperture(s) of the orifice plate. In some examples, the pattern(s) and/or structure(s) is produced by applying photoresist that is patterned and then removed by wet etching. In some examples, the mandrel undergoes a number of processes to produce the orifice plate (e.g., a mandrel mask) such as a physical vapor deposition (PVD) process, a plasma-enhanced chemical vapor deposition (PECVD) process, a chemical vapor process (CVP) and/or a photolithography process. The PVD process may be used to sputter a layer of stainless steel and/or chrome on the mandrel. The CVP and/or the PECVD process may be used to deposit a silicon carbide layer on the mandrel. The stainless steel layer and/or chrome layer and the photolithography process may be used to pattern the silicon carbide layer. In some examples, the mandrel is immersed in a plating bath (e.g., nickel, gold and/or platinum plating bath) where the bath plates the entire surface of the mandrel except where the nonconductive silicon carbide is located. In examples in which the plating bath is a nickel plating bath, the nickel from the bath defines the patterns, shapes and/or features of the orifice plate.

As the plating gets thicker, the nickel plates over the edges of the silicon carbide and defines structures (e.g., orifice nozzle(s), pattern(s), aperture(s), bore(s), etc.) of the orifice plate. After a particular amount of time has elapsed and the mandrel and the orifice plate are removed from the plating bath, the orifice plate (e.g., a nickel electroform) may be removed and/or peeled off of the mandrel and electroplated with, for example, gold, palladium and/or rhodium. The size and/or thicknesses of the orifice plate and/or the associated bore(s) and/or nozzle(s) may be proportional to the amount of time that the mandrel is immersed in the nickel bath, the pad size (e.g., a silicon carbide pad that defines the bore size), etc.

In some examples, to couple and/or integrate the orifice plate with the wafer and/or substrate having a nanostructure(s) and/or nanoparticles, a concave side of the orifice plate is positioned to face the substrate such that a chamber is defined between the orifice plate and the wafer and/or substrate. In some such examples, the nanostructure(s) and/or nanoparticles are positioned within the chamber to substantially prevent the nanostructure(s) and/or nanoparticles from being prematurely exposed to a substance that the nanostructure(s) and/or nanoparticles are intended to detect. The orifice plate may be coupled to the wafer and/or substrate using a gang-bond process (e.g., thermocompression bonding that bonds metals). To reduce or even prevent the unintentional exposure of the nanostructure(s) and/or nanoparticles to a substance such as an analyte that the nanostructure(s) and/or nanoparticles are intended to detect, a polymer tape covers a fluidic inlet port(s), an aperture(s), etc., of the orifice plate.

To use the example testing and/or detecting devices to detect for a substance of interest, in some examples, the polymer tape is at least partially removed from the orifice plate to expose the fluidic port(s), the aperture(s), the chamber, the substrate, the nanostructures and/or the nanoparticles to the environment, chemical, substance, gas, analyte, etc., to be tested. After the substrate, nanostructure and/or nanoparticles have been exposed to the environment and/or substance (e.g., chemical, gas, analyte, etc.) whose presence is to be detected and/or tested, the testing device is placed in or adjacent to an example reading device. The reading device may include a light source that illuminates the substrate, nanostructure and/or nanoparticles. In some examples, the light scattered by the substrate, nanostructure and/or nanoparticles (e.g., Raman scattering in Surface Enhanced Raman spectroscopy, fluorescence in Enhanced Fluorescence spectroscopy or luminescence in Enhanced Luminescence spectroscopy) is monitored using a spectrometer, photodetector, etc., having appropriate guiding and/or filtering components. In some examples, the results obtained by the reading device are displayed on a monitor and/or are indicative of detection or no detection of the substance being tested and/or looked for.

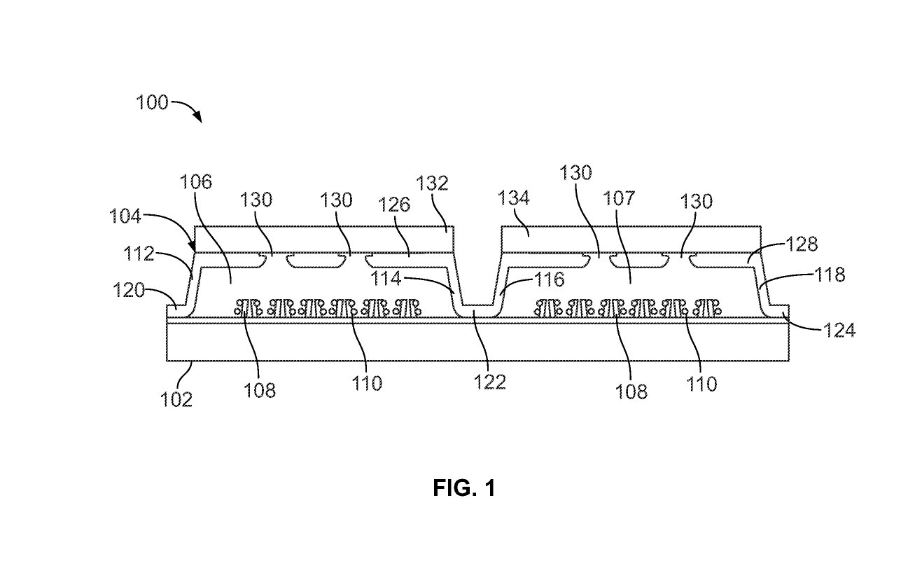

FIG. 1 depicts an example testing and/or detection device 100 constructed in accordance with the teachings of this disclosure. The testing device 100 of the illustrated example includes a substrate 102 and an orifice plate and/or housing 104 defining first and second chambers 106, 107 in which nanostructures 108 and/or nanoparticles 110 are positioned. The substrate 102 may be made of any suitable material such as glass, plastic, paper, Polydimethylsiloxane, a transparent material, rubber and/or a membrane, for example. The orifice plate 104 may be made of any suitable material such as metal, nickel, gold and/or platinum, for example. The nanoparticles 110 may include gold and/or silver and/or any other element or chemical that may react with, respond to, collect, etc., a substance of interest such as an analyte. The nanostructures 108 and/or the nanoparticles 110 of the illustrated example facilitate detection of an analyte to which they have been exposed. In some examples, the nanostructures 108 are at least partially transparent and/or include pillar and/or conical structures. In some examples, after exposure to a substance or chemical, the pillar structures are pulled together to form nanoparticle assemblies having controllable geometries for enhanced spectroscopy analysis. In some examples, after exposure to a substance or chemical, the conical structures have relatively sharp tips that produce relatively strong enhancement for spectroscopy analysis. In some examples, the substrate 102 is transparent to enable detection and/or analysis of the nanostructures 108 and/or nanoparticles 110 through the substrate 102.

In the illustrated example, to define portions of the chambers 106, 107, the orifice plate 104 includes tapered portions 112, 114, 116, 118, coupling portions 120, 122, 124 and top portions 126, 128 defining apertures and/or fluidic inlet bores 130. In some examples, the coupling portions 120, 122, 124 and the top portions 126, 128 are spaced apart and substantially parallel to one another and are coupled via the respective tapered portions 112, 114, 116, 118. As used herein, the phrase “substantially parallel” means within about 10 degrees of parallel or less. In other examples, the coupling portions 120, 122, 124 are spaced apart from the top portions 126, 128 but the coupling portions 120, 122, 124 are not parallel to the top portions 126, 128.

As illustrated in the example of FIG. 1, the first chamber 106 is defined by the tapered portions 112, 114 and the top portion 126. The second chamber 107 is defined by the tapered portions 116, 118 and the top portion 128. In this example, the coupling portion 122 is coupled to the substrate 102. The coupling portion 122 and the substrate 102 are joined to form a hermetic seal to separate the first and second chambers 106, 107 such that a first substance may be added to the first chamber 106 at a first time and a second substance may be added to the second chamber 107 at a second time without intermingling.

To enclose the first and second chambers 106, 107 of the illustrated example, seals 132, 134 are removably coupled to the top portions 126, 128. The seals 132, 134 of the illustrated example are hermetic seals and may be made of polymer tape, plastic, a transparent material, plastic sheeting, foil material, foil sheeting, a membrane, wax and/or Polydimethylsiloxane. In some examples, the seals 132, 134 are transparent to enable a reading device to take measurements of the nanostructures 108 and/or nanoparticles through the seals 132, 134 attached to the housing 104.

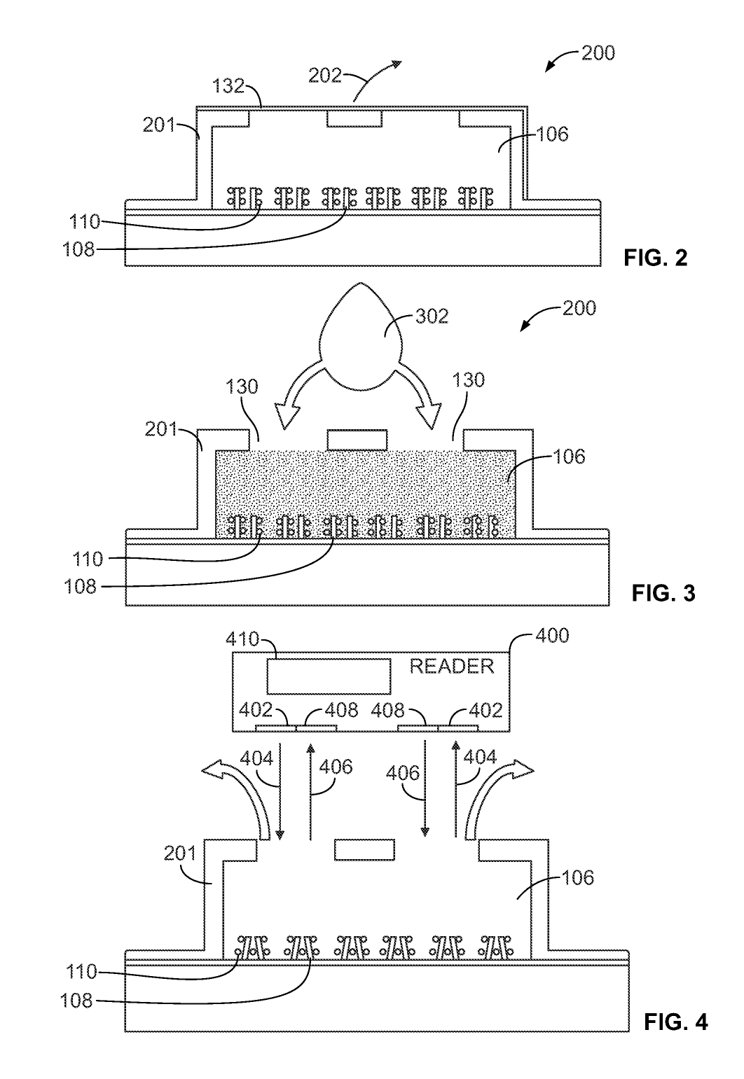

FIG. 2 depicts an example testing and/or detecting device 200 with the seal 132 about to be removed in a direction generally indicated by arrow 202. The example testing device 200 is similar to a first half of the testing device 100 of FIG. 1. As a result, like reference numerals are used to refer to like parts in FIGS. 1 and 2. After the seal 132 is removed from an orifice plate and/or housing 201 of the testing device 200, air and/or other gas within a test environment (e.g., a room) in which the testing device 200 is positioned flows through the apertures 130 and into the chamber 106 where it is exposed to the nanostructures 108 and/or nanoparticles 110. The air and/or other gas within the test environment may or may not include the analyte that the nanostructures 108 and/or the nanoparticles 110 are intended to detect.

FIG. 3 depicts the example testing and/or detecting device 200 with the seal 132 removed from the orifice plate 201 and a solution or chemical 302 to be analyzed being added to the chamber 106. The solution or chemical 302 may or may not include the analyte that the nanostructures 108 and/or the nanoparticles 110 are intended to detect. In some examples, after the nanostructures 108 and/or the nanoparticles 110 have been exposed to the solution or chemical 302, the chamber 106 is recovered by the seal 132 and/or another seal to ensure that the nanostructures 108 and/or nanoparticles 110 are not contaminated with exposure to a non-testing environment after the test has occurred.

FIG. 4 illustrates the example testing device 200 of FIG. 2 after exposure to an environment that may or may not contain an analyte(s) and/or after the solution or chemical 302 has been added to the chamber 106. In some examples, after the solution or chemical 302 is added to the chamber 106, a portion of the solution or chemical 302 evaporates leaving particle(s) on the nanostructures 108 and/or the nanoparticles 110. In some examples, the evaporation of the solution or chemical 302 pulls and/or causes the nanostructures 108 to be pulled together reducing a distance and/or gap between the nanostructures 108. The particle(s) may or may not contain the analyte being tested for.

FIG. 4 also illustrates an example reading device 400 constructed in accordance with the teachings of this disclosure. In this example, the reading device 400 includes a light source 402 that emits photons 404 into the chamber 106. In the illustrated example, the photons are scattered by the nanostructures 108 and/or nanoparticles 110. In some examples, some of the scattered photons 406 are detected and/or monitored by a spectrometer and/or photodetector 408 of the reading device 400. In some examples, the reading device 400 uses the detected and/or monitored photons 406 along with appropriate guiding and/or filtering components to generate results (e.g., information relating to the presence or absence of an analyte to be detected) which are displayed on a monitor 410.

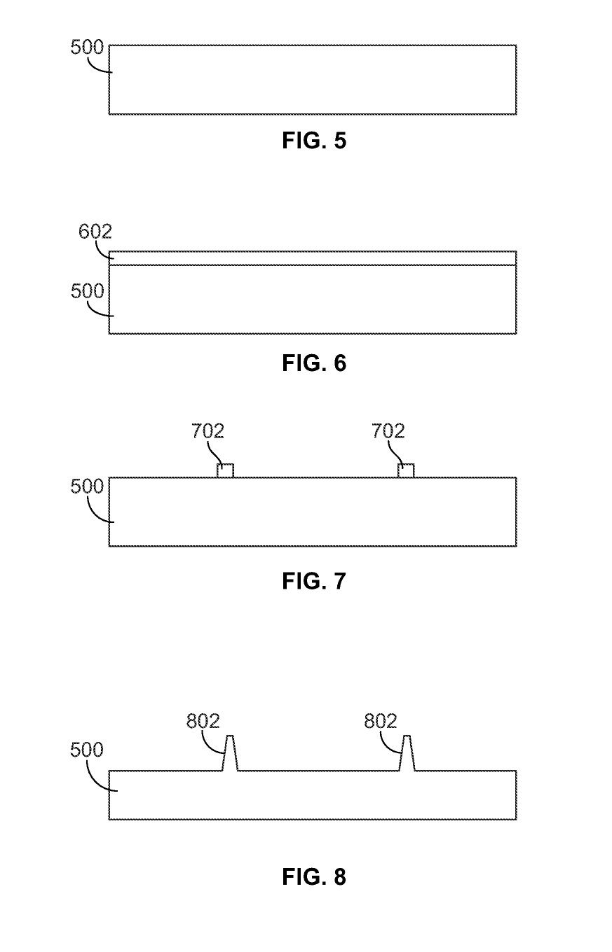

FIGS. 5-12 depict an example process of producing a portion of an example orifice plate 1200 that can be used to implement the example orifice plate(s) 104 and/or 201 of FIGS. 1 and/or 2. In the illustrated example and as shown in FIGS. 5-7, the orifice plate 1200 is produced using a mandrel 500 on which photoresist 602 (FIG. 6) is applied and patterned to form structure(s) 702 (FIG. 7). The mandrel 502 may be made of glass, soda-lime-silica glass, etc.

FIG. 8 shows the mandrel 500 after wet etching using hydrogen fluoride. The photoresist structure 702 functions as mask during the wet etching. After the photoresist structure 702 are removed, elongated, trapezoidal and/or conical structure(s) 802 remain, which were previously beneath the photoresist mask.

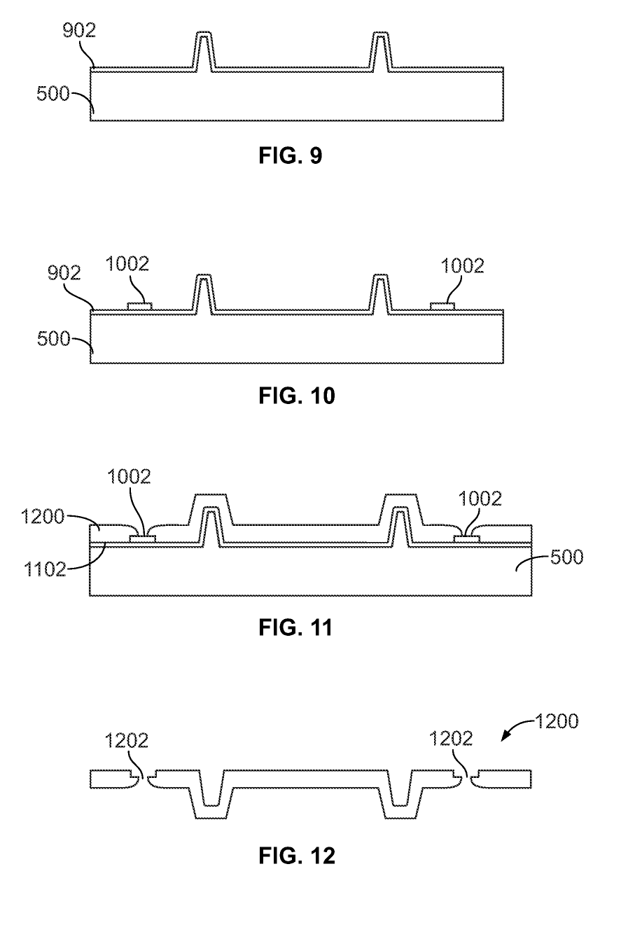

FIG. 9 depicts the mandrel 500 after undergoing a physical vapor deposition process to add (e.g., sputter on) a layer 902 of stainless steel and/or chrome that forms a mandrel mask on the mandrel 500.

FIG. 10 depicts the mandrel 500 after undergoing plasma-enhanced chemical vapor deposition (PECVD) and photolithography processes. The PECVD process deposits silicon carbide on the layer 902 and the photolithography process patterns the deposited silicon carbide to form silicon carbide structure(s) 1002 used to define corresponding aperture(s) 1202 of the orifice plate 1200.

To form the orifice plate 1200, in some examples and as shown in FIG. 11, the mandrel 500 is immersed in a nickel plating bath that plates a surface 1102 of the mandrel 500 everywhere except where the nonconductive silicon carbide 1002 is located. The nickel from the bath, thus, defines the pattern(s), shape(s) and/or feature(s) of the orifice plate 1200. After the mandrel 500 and the orifice plate 1200 are removed from the plating bath, the orifice plate 1200 may be removed and/or peeled off of the mandrel 500 as illustrated in FIG. 12.

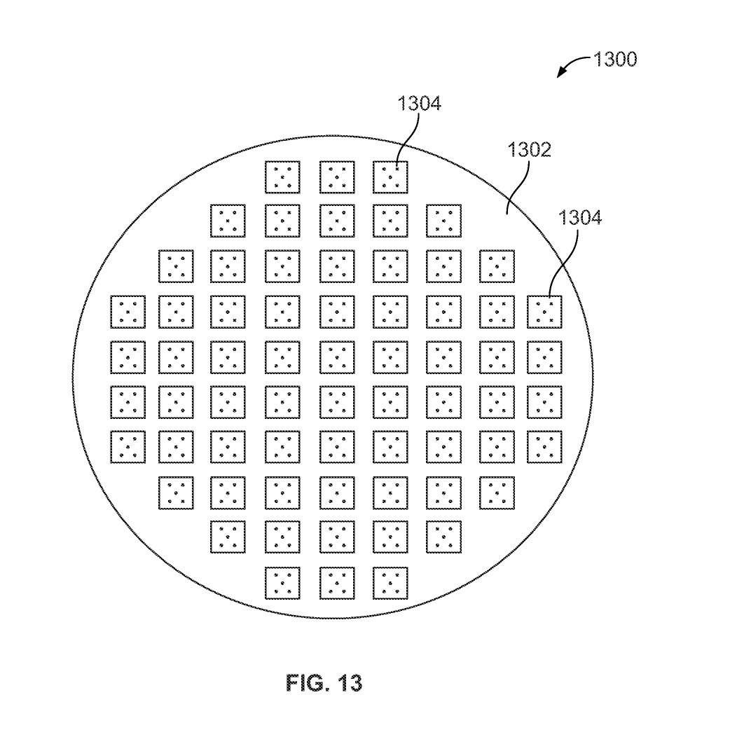

FIG. 13 shows an example multi-chamber testing and/or detection device 1300. The device 1300 includes an orifice plate and/or housing 1302 defining a plurality of chambers 1304 in which nanostructures and/or nanoparticles are positioned. In some examples, the device 1300 includes seals that cover each of the chambers 1304 such that a first chamber 1304 can be exposed at a first time and a second chamber 1304 can be exposed at a second time. In other examples, the device 1300 includes seal(s) that covers more than one of the chambers 1304. In some examples, the orifice plate 1302 separates the nanostructures and/or nanoparticles into the separate chambers 1304 having a known volume for quantitative analysis.

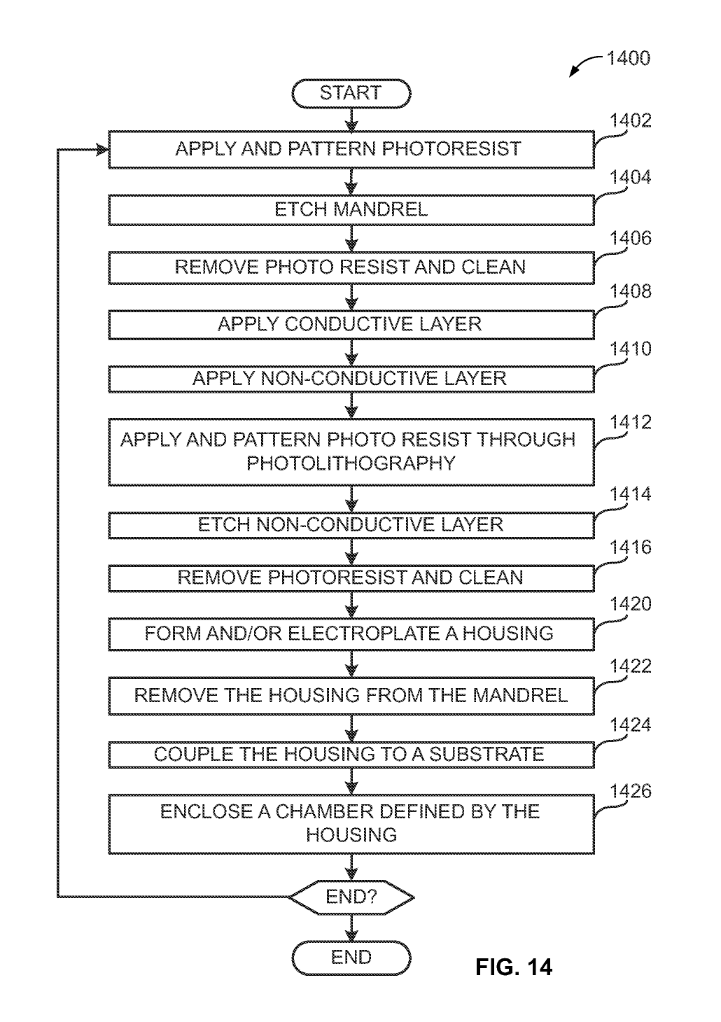

FIG. 14 illustrates an example method 1400 of manufacturing the example testing devices of FIGS. 1-13. Although the example method 1400 of FIGS. 1-13 are described with reference to the flow diagram of FIG. 14, other methods of implementing the method 1400 may be employed. For example, the order of execution of the blocks may be changed, and/or some of the blocks described may be changed, eliminated, sub-divided, or combined.

The example method 1400 of FIG. 14 begins by applying and patterning photoresist on the mandrel 500 through photolithography (block 1402). In some examples, the mandrel 500 is etched (e.g., wet etched, reactive-ion etch (RIE)) using hydrogen fluoride after which the photoresist structure 702 is removed and the mandrel 500 is cleaned to show elongated, trapezoidal and/or conical structure(s) 802, which were previously beneath the photoresist mask (blocks 1404, 1406). To form a mandrel mask on the mandrel 500, the mandrel 500 may undergo a physical vapor deposition process to add (e.g., sputter on) the layer 902 of conductive material, stainless steel and/or chrome (block 1408). To apply the non-conductive layer and/or silicon carbide to define the corresponding aperture(s) 1202 of the orifice plate 1200, the mandrel 500 may undergo plasma-enhanced chemical vapor deposition (PECVD) and photolithography processes (block 1410). Photoresist may be applied and patterned on the mandrel 500 through photolithography (block 1412). In some examples, the non-conductive layer is etched (e.g., wet etched, reactive-ion etched (RIE)) using hydrogen fluoride after which the photoresist structure 702 is removed and the mandrel 500 is cleaned (blocks 1414, 1416).

To form the orifice plate 1200, in some examples the mandrel 500 is positioned and/or immersed in a plating bath to form a metal housing and/or orifice plate 104, 201, 1302 and/or electroplated with, for example, gold, palladium and/or rhodium (block 1420). In some examples, the conductiveness of the housing 104, 201, 1302 enables the housing 104, 201, 1302 to act as an electronic terminal for sampling. The plating bath may include a metal such as nickel, gold and/or platinum. In some examples, the metal of the plating bath does not plate against the silicon carbide because the silicon carbide is nonconductive. Thus, apertures 130 of the housing 104, 201 are defined where the silicon carbide is located and the silicon carbide may, thus, be used to control the size of the apertures 130.

After a particular amount of time, in some examples, the mandrel 500 and the housing 104, 201, 1302 are removed from the plating bath and the housing 104, 201 is removed and/or peeled from the mandrel 500 (block 1422). The housing 104, 201, 1302 of the illustrated example is then coupled to the substrate 102 such that nanoparticles 110 of the substrate 102 are positioned within a chamber 106 defined by the housing 104, 201, 1302 (block 1424). To enclose the chamber 106 and/or cover apertures 130 defined by the housing 104, 201, a seal 132 is coupled to the housing 104, 201, 1302 (block 1426). The method 1400 then terminates or returns to block 1402.

As set forth herein, an example device to detect a substance includes an orifice plate defining a first chamber. A substrate is coupled to the orifice plate. The substrate includes nanostructures positioned within the first chamber. The nanostructures are to react to the substance when exposed thereto. The device also includes a seal to enclose at least a portion of the first chamber to protect the nanostructures from premature exposure. In some examples, the nanostructures include at least one of pillar structures or conical structures. In some examples, the orifice plate includes at least one of nickel, gold, platinum, palladium, or rhodium.

In some examples, the orifice plate is electroplated with at least one of gold, palladium, or rhodium. In some examples, the seal includes at least one of a polymer material, a flexible material, or a removable material. In some examples, the seal includes a hermetic seal. In some examples, the seal includes at least one of polymer tape, plastic, foil, a membrane, wax, or Polydimethylsiloxane. In some examples, the substrate includes at least one of a Surface Enhanced Raman spectroscopy substrate, a self actuating Surface Enhanced Raman spectroscopy substrate, an Enhanced Fluorescence spectroscopy substrate, or an Enhanced Luminescence spectroscopy substrate. In some examples, the orifice plate defines a second chamber which is sealed from the first chamber. At least some of the nanostructures are positioned within the second chamber. A second seal is to enclose at least a portion of the second chamber to protect the nanostructures from premature exposure.

An example method of producing a device to detect a substance includes immersing a mandrel in a plating bath to form a metal housing. The mandrel includes a pattern or a structure corresponding to an aperture or a structure of the housing. The method includes removing the housing from the mandrel and coupling the housing to a substrate. The housing is to define a chamber in which nanostructures of the substrate are positioned. The nanostructures to evidence exposure to the substance if exposed thereto. In some examples, the plating bath includes nickel, gold, or platinum. In some examples, the method includes electroplating the housing with gold, palladium, or rhodium. In some examples, the housing includes an orifice plate. In some examples, the pattern or the structure of the mandrel is defined by silicon carbide. In some examples, the mandrel includes at least one of a stainless steel layer or a chrome layer. In some examples, the method includes coupling a seal to the housing to cover the aperture of the housing and protect the nanoparticles from premature exposure.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A device to detect a substance, comprising:
an orifice plate defining a first chamber;
a substrate coupled to the orifice plate, the substrate comprising nanostructures positioned within the first chamber, the nanostructures to react to the substance when exposed thereto; and
a seal to enclose at least a portion of the first chamber to protect the nanostructures from premature exposure.

2. The device of claim 1, wherein the orifice plate comprises at least one of nickel, gold, platinum, palladium, or rhodium.

3. The device of claim 1, wherein the nanostructures comprise at least one of pillar structures or conical structures.

4. The device of claim 1, wherein the orifice plate is electroplated with at least one of gold, palladium, or rhodium.

5. The device of claim 1, wherein the seal comprises at least one of a polymer material, a flexible material, or a removable material.

6. The device of claim 1, wherein the seal comprises a hermetic seal.

7. The device of claim 1, wherein the seal comprises at least one of polymer tape, plastic, foil, a membrane, wax, or Polydimethylsiloxane.

8. The device of claim 1, wherein the substrate comprises at least one of a Surface Enhanced Raman spectroscopy substrate, a self actuating Surface Enhanced Raman spectroscopy substrate, an Enhanced Fluorescence spectroscopy substrate, or an Enhanced Luminescence spectroscopy substrate.

9. The device of claim 1, wherein the orifice plate defines a second chamber which is sealed from the first chamber, at least some of the nanostructures positioned within the second chamber, a second seal to enclose at least a portion of the second chamber to protect the nanostructures from premature exposure.

10. A method of producing a device to detect a substance, comprising:
immersing a mandrel in a plating bath to form a metal housing, the mandrel comprising a pattern or a structure corresponding to an aperture or a structure of the housing;
removing the housing from the mandrel; and
coupling the housing to a substrate, the housing to define a chamber in which nanostructures of the substrate are positioned, the nanostructures to evidence exposure to the substance if exposed thereto.

11. The method of claim 9, wherein the plating bath comprises nickel, gold, or platinum.

12. The method of claim 9, further comprising electroplating the housing with gold, palladium, or rhodium.

13. The method of claim 9, wherein the housing comprises an orifice plate.

14. The method of claim 9, wherein the mandrel comprises at least one of a stainless steel layer or a chrome layer.

15. The method of claim 9, further comprising coupling a seal to the housing to cover the aperture of the housing and protect the nanoparticles from premature exposure.
